(19) United States
(12) Patent Application Publication
(10) Pub. No.: US 2006/0029692 A1
(43) Pub. Date: Feb. 9, 2006

(54) Supplementary food for health using kimchi as principal raw material and method producing the same

(76) Inventor: Young Kang, San Jose, CA (US)

Correspondence Address: PATENT OFFICE OF DR. CHUNG S. PARK, P. O. BOX 62312, SUNNYVALE, CA, 94088-2312, US

(21) Appl. No.: 10/913,083

(22) Filed: Aug. 6, 2004

(51) Int. Cl. A23F 3/16

(52) U.S. Cl. 426/52

(57) ABSTRACT

A method for preparing powder that includes kimchi in a form of tablet or capsule. Vegetables are pickled with salt and mixed with condiments that contain various spices. Then, lactic acid bacteria that act as fermenting agents are added to the prepared mixture of vegetables and condiments. Next, the mixture is fermented and aged to make kimchi. Subsequently, the kimchi is freeze-dried, ground into powder and mixed with bean sprout powder. The mixed powder is then contained in a form of tablet or capsule for easy consumption.

### BACKGROUND OF THE INVENTION

1. Field of the Invention

The present invention relates to methods for producing kimchi as a supplementary food, and more particularly to methods for producing kimchi powder in the form of a tablet or a capsule for easy consumption.

2. Description of the Background Art

Kimchi is probably the most important side dish in the Korean diet, second only to rice. Kimchi may be made of various vegetables mixed with condiments and has a unique taste and flavor depending on the type of ingredient as well as fermenting conditions. Hereinafter, the term “condiments” refer to a mixture of spices. Even though Koreans started eating kimchi several hundred years ago, kimchi was not well known to foreigners until quite recent years. However, recent extensive nutritional studies on kimchi revealed nutritious ingredients contained in kimchi, either from raw ingredients or chemical reactions during the fermentation and aging processes, and kimchi started getting attention of people around the world and recognition as part of a well-balanced healthy diet.

According to research performed on kimchi, kimchi has not only vitamins and minerals that are known to nourish human bodies, but also has lactic acid bacteria as well as dietary fiber that promote active intestinal activities that help cleansing intestines and strengthening human immune system. Hereinafter, the term “lactic acid bacteria” refers to, but not limited to, Leuconostoc citreum, Leuconostoc cremoris, Leuconostoc lactis and Leuconostoc mesenteroides, which are the most abundant in kimchi. Typically, lactic acid and various types of materials beneficial to human immune system are generated during the aging process of kimchi. Also, red pepper, garlic, ginger, and cabbage contain capsaicin and sitosterol that are well known to burn and dissolve fat cells, and thus beneficial for those who hope to lose weight.

Despite of such beneficial ingredients contained in kimchi, kimchi has several challenging problems to overcome in commercial distribution and easy consumption thereof. Firstly, as kimchi is a fermented product, the temperature of kimchi container as well as the delivery procedure may have big impact on its freshness and taste. If proper care is not given, it is possible for kimchi to get rotten during delivery to consumers. Secondly, some of the major ingredients of kimchi, such as red pepper, garlic, ginger, and fermented fish sauce, contain a strong smell that may not be pleasant for those who are not used to such a smell. For these reasons, many consider kimchi to be a challenging product to distribute commercially and internationally.

Attempts have been made to compensate for these problems, such as eliminating some of the strong scent ingredients, or the fermenting procedure from the traditional kimchi. However, such products may not have the same beneficial effects (such as strengthening immune systems or burning fat cells) as those that have been traditionally fermented. Recently, people in Japan are beginning to eat a kimchi-like food, called ‘kimuchi’. Kimuchi has been modified in order to satisfy the taste of Japanese people and does not contain some of the key ingredients of traditional kimchi. Also, kimuchi skips the fermenting procedure, and as a consequence, does not have the smell that traditional kimchi has. However, ‘kimuchi’ does not have the beneficial effects that traditional kimchi has, either.

Kimchi may be made of any kind of vegetables that contain sugar and lactic acid bacteria, and among them, Napa cabbage may be the most preferred choice. Traditionally, Korean people produce a large amount of kimchi in the late fall (November). The reason for this is to use the cold temperature in winter so that kimchi does not get spoil for several months. During the winter season, the cold temperature suppresses the multiplication of malicious bacteria (such as saprogenous bacillus), while lactic acid bacteria can multiply without being affected by the cold weather. Therefore, cold temperature would be most ideal for keeping the taste of kimchi at its best.

The recipe for making traditional kimchi has been passed on for generations for hundreds of years. The typical steps are as follows: first, Napa cabbages that are hard and fresh to the core may be selected and cut into either half or four slices. Then, the cabbages are soaked in about 15% salt solution and allowed to drain. While the cabbages are in salt solution, most of the malicious bacteria may be killed. However, lactic acid bacteria are able to thrive and later act as fermenting agents. Second, white radishes are cut into thin slices to prepare condiments that will be inserted between the leaves of the soaked cabbages. Fermented fish sauce and red pepper powder are added to the thinly sliced radishes. In a separate bowl, oyster, garlic, ginger, green onion, shrimp, fermented baby shrimp sauce, and parsley are mixed and seasoned with salt. Then, the mixture prepared in the separate bowl are mixed with the thin slices of radishes to make the condiments. Third, the condiments are inserted in between the leaves of the cabbage, and the cabbage containing the condiments is put into a jar. The cabbage is pressed firmly further down into the jar in order to force out any pockets of air remaining in the jar. Otherwise, these pockets of air allow malicious bacteria to thrive and reproduce, thereby spoiling the cabbage. By forcing out the pockets of air, the malicious bacteria cannot multiply; however, the lactic acid bacteria required to ferment the cabbage into kimchi can still reproduce without the air. The kimchi is typically aged at a temperature of 0-4° C., which allows the lactobacillus to survive and multiply, while preventing the growth of malicious bacteria.

Kimchi has nutrients and ingredients that may have beneficial effects on the body. The cabbage used in traditional kimchi contains carotene, vitamin C, and dietary fibers. The radish contains vitamins A and C, calcium, phosphorus, iron, and dietary fibers; these nutrients assist in digestive processes to prevent constipation and colon cancer. Red pepper contains capsaicin, which may suppress accumulation of body fat and promote energy metabolism, as disclosed by Koichiro Ohnuki et al. in Biosci., Biotechnol., Biochem., 65 (12), 2735-2740, 2001. Garlic and ginger also increase metabolism as well as the body's rate of perspiration. For those with slower metabolisms or weight problems, eating kimchi may increase one's metabolism, thereby promoting weight loss and a higher metabolism.

Kimchi that has been aged for 15-20 days may have a count of lactic acid bacteria from several tens of million to one hundred million colony forming units (cfu) per gram of kimchi. Leuconostoc citreum is active at the beginning stage of the fermenting process, while lactobacillus, another type of lactic acid bacteria, is active in the later stage of the fermentation process. These two types of bacteria enter the human intestine, where they promote the growth of bifidus bacteria. The increased growth of bifidus bacteria facilitates bowel movement. As facilitating bowel movement is essential for losing weight, kimchi is considered as an effective supplement for weight loss.

The main functions of the typical ingredients in kimchi are as follows: 1) cabbage (sitosterol), which burns fat cells, 2) red pepper (capsaicin), which decomposes fat cells, 3) garlic (alicin), which serves as a natural antibiotics that kills harmful bacteria, as well as boosting stamina, 4) ginger (gingerol), which increases metabolism, 5) onions, which promotes blood circulation and lowering blood pressure, and 6) sugar, which is dissolved and turned into an insoluble dextran that encapsulates Leuconostoc citreum so that the Leuconostoc citreum may reach the intestine without being killed by the stomach acid.

As mentioned, kimchi is a nutritious food. However, its unique and strong scent along with its spiciness makes kimchi an unsavory food for foreigners to consume. Since kimchi is a fermented food, any expulsion of gas through the mouth is foul and almost unbearable to foreigners. Preserving and distributing kimchi is very difficult due to its dependence on container temperature, so it becomes hard to commercialize and distribute kimchi throughout the world.

### SUMMARY OF THE INVENTION

To overcome these difficulties, the present invention provides a method to freeze-dry the kimchi containing low salt concentration and large population of lactic acid bacteria, then turn it into a powder and make a tablet or capsule of the powder for easy consumption as a supplementary food for health and/or weight loss. The kimchi powder contains the various types of functional materials and nutrients present in kimchi. Bean sprout powder that may be added to the kimchi powder can prevent expulsion of gas through the mouth, thereby allowing kimchi to be easily commercialized and readily available to everyone.

According to one embodiment of the present teachings, a method for preparing powder that includes kimchi in a form of tablet or capsule is disclosed. Vegetables are pickled with salt and mixed with condiments that contain various spices. Then, lactic acid bacteria that act as fermenting agents are added to the mixture of vegetables and condiments. Next, the mixture is fermented and aged to make kimchi. Subsequently, the kimchi is freeze-dried, ground into powder and mixed with bean sprout powder. The mixed powder is then contained in a form of tablet or capsule for easy consumption.

These and other advantages and features of the invention will become apparent to those persons skilled in the art upon reading the details of the methods and systems as more fully described below.

### DESCRIPTION OF THE DRAWINGS

FIG. 1 a flow chart illustrating exemplary steps of preparing powder that comprises kimchi in a form for easy consumption in accordance with one embodiment of the present teachings.

### DETAILED DESCRIPTION OF THE INVENTION

The detailed embodiments of the present invention are disclosed herein. It should be understood, however, that the disclosed embodiments are merely exemplary of the invention, which may be embodied in various forms. Therefore, the detail disclosed herein is not to be interpreted as limited, but merely as the basis for the claims and as a basis for teaching one skilled in the art how to make and/or use the invention.

As mentioned, kimchi may be made of vegetables such as Chinese cabbage, Western cabbage, Napa cabbage, radishes, cucumbers, mustard greens, dandelions, chicory, endives, perilla leaves, bell flower plan roots, leeks, chives, garland chrysanthemum, kales, burdocks, ginseng root, collard greens, lettuce, squash and broccoli. For the purpose of simplicity, Napa cabbage is assumed to be the vegetable selected to make kimchi in the disclosure. However, it should be apparent to those of ordinary skill that other vegetables may be used to make kimchi as long as they contain lactic acid bacteria and sugar.

The present invention provides a method for producing kimchi powder in a form of tablet or capsule for easy consumption as a supplementary food for health, particularly for individuals who wish to lose weight. More importantly, in contrast to traditional methods, the produced powder contains only a small amount of salt and is fortified with large amounts of lactic acid bacteria, while the functional materials and nutrients present in kimchi is preserved. In accordance with the preferred embodiment of the present teachings, kimchi powder may be manufactured by the following steps.

Pickle cabbage with salt: Napa cabbage may be cut into pieces, washed, rinsed, and dewatered thoroughly. Next, salt at an amount of, but not limited to, 1-1.2% by weight of the cabbage is sprinkled on the cabbage and left for 4-6 hours to draw water therefrom. During this step, the salt concentration in the cabbage may be measured by a salt meter. If the salt meter indicates that the salt concentration in the cabbage does not increase any further, the water drawn out from the cabbage by the salt may be discarded.

It is known that high concentration of salt in diet may cause negative impact on the liver and/or kidneys. Typically, traditional kimchi has a salt concentration of 2.5%. However, if it is dried and ground into powder, the salt concentration becomes approximately 25% due to the loss of water in the kimchi. Thus, the powder made of traditional kimchi may cause unfavorable side effects on the consumers unless the concentration of salt is lowered.

Mix the pickled cabbage with condiments: In this step, the pickled cabbage is mixed with prepared condiments. Condiments may be a mixture of radish at amount of 10-20% by weight of the cabbage, onion at amount of 2-5% by weight of the cabbage, green onion at amount of 1-2% by weight of the cabbage, garlic at amount of 1-2% by weight of the cabbage, red pepper at amount of 1-2% by weight of the cabbage and ginger at amount of 0.5-2.0% by weight of the cabbage. In contrast to the traditional condiments, the condiments of the present embodiment does not include fermented fish sauce for the following reasons: 1) the fermented fish sauce may contain various malicious bacteria that can spoil the kimchi, 2) absence of the fermented fish sauce eliminates odor, and 3) the decay of proteins present in the fermented fish sauce can cause the decay and/or a change in the chemical composition of other nutrients present in the kimchi.

However, the absence of the fermented fish sauce also means that the beneficial amino acids present in the fish sauce are absent as well. To compensate for this lack of amino acids, bean amino acids may be added to the kimchi. The presence of the bean amino acid may also serve as a catalyst to expedite the fermenting process of the kimchi. Another benefit of the higher concentration of bean amino acids is that the kimchi can provide a viable alternative to meats for vegetarians. In one embodiment, cystein and/or tryptophan may be added to the kimchi so as to provide a better environment for the growth and multiplication of Leuconostoc citreum, which is a fermenting agent.

Even though the amount of each ingredient contained in the condiments is set forth above, it should be apparent to the ordinary skill in the art that the specified amounts can be varied without deviating from the present teachings. Also, it should be noted that the present invention may be practiced with other ingredients and/or without one or more of the mentioned ingredients.

Add lactic acid bacteria to the mixture: In this step, lactic acid bacteria, such as Leuconostoc citreum, may be added to the mixture of cabbage and condiments prepared in the previous step. Approximately, but not limited to, 10⁶-10⁷ cfu per gram of the mixture (or, equivalently 10 ml per kilogram of the mixture) may be added to the mixture. The entire mixture is then subjected to a fermenting process of less than three days at 16-18° C., or more than seven days at 4-5° C., followed by an aging period of 3 days at 0-4° C. During this period of fermentation and aging process, the lactic acid bacteria may multiply to a population of 10⁹ per gram of kimchi. Compared to traditionally prepared kimchi, this population of lactic acid bacteria is 10 times that of the traditional kimchi.

It is noted that the size of each ingredient in the mixture of cabbage and condiments may affect the fermentation period. For example, to expedite the fermentation process, the mixture of cabbage and condiments may be ground into smaller pieces prior to adding lactic acid bacteria, which may translate into savings of production cost. Thus, it should be apparent to those of ordinary skill in the art that the fermentation period set forth above may vary in conjunction with the size of each ingredient in the mixture of cabbage and condiments.

One of the reasons for adding lactic acid bacteria into the mixture (or, equivalently fortifying the mixture with additional lactic acid bacteria) is that they may provide the human immune system with a beneficial chemical. As the lactic acid bacteria die, the cell membranes secrete a chemical that can boost the immune system.

Another reason for the addition of lactic acid bacteria is that it can suppress the growth of malicious bacteria. As described in the first step, a relatively smaller amount of salt (1-1.2% by weight) than traditional kimchi may be added to the cabbage. This small amount of salt may not be enough to eliminate various harmful bacteria in the cabbage. Then, the bacteria may multiply and spoil the kimchi soon thereafter before the kimchi finishes the fermenting process. However, when lactic acid bacteria are added to the mixture in this step, they may multiply at a faster rate than the harmful bacteria, which may suppress the growth and multiplication of the harmful bacteria. The kimchi produced in accordance with the aforementioned processes may have the salt concentration of 0.85% -0.9% by weight, the pH level of 4.1-4.5 and the acidity level of 0.7-0.9. Thus, the salt concentration of the kimchi may be about a third of that of traditional kimchi, while the kimchi may still retain the flavor of well-fermented traditional kimchi and contain lactic acid bacteria about 10 times that of traditional kimchi.

Yet another reason for adding lactic acid bacteria is that much of the lactic acid bacteria may be killed during a freeze-drying process of the subsequent step. Thus, by fortifying the mixture with additional lactic acid bacteria, the population of lactic acid bacteria may be maintained at or above an intended level.

It is well known that the human stomach secretes strong acid to kill germs and bacteria contained in swallowed food. As the stomach acid does not discriminate good bacteria from bad ones, much of the beneficial lactic acid bacteria may be killed before they reach the intestine. In order for the lactic acid bacteria to reach the intestine and promote intestinal activities that would help cleanse the intestine and strengthen the human immune system, the lactic acid bacteria must survive the stomach acid. In one embodiment, a protective coating of protein and/or starch may be applied on the surface of each lactic acid bacterium. The coating, referred to as “microcapsule”, may be formed by adding chitosan to the mixture of cabbage and condiments in the present step. Subsequent to the fermentation process, chitosan at an amount of, but not limited to, 2% by weight of the mixture may be added to the kimchi by which lactic acid bacteria will be coated with chitosan that helps the bacteria survive during the downstream freeze-drying process as well as protect from being killed by stomach acid and thus reach intestine effectively. Another benefit of chitosan is that it may hold heavy metal compound and reduce fat storage to promote weight loss, as disclosed by L-K Han et al. in International Journal of Obesity, Vol. 23, 174-179 (1999).

Freeze-dry the aced kimchi and grind the freeze-dried kimchi: The kimchi prepared in the previous step is freeze-dried and ground into kimchi powder that has a particle size of about 180 microns (or, equivalent to mesh #80). Although some portion of the lactic acid bacteria in the kimchi may die during this process, the surviving cells in the freeze-dried powder may still outnumber those of traditional kimchi. As mentioned previously, lactic acid bacteria may secrete a beneficial chemical, such as dextran, to the immune system when they die, and so the dead lactic acid bacteria cells may boost the immune system.

As mentioned, one of the reasons for adding lactic acid bacteria may be maintaining the population of lactic acid bacteria above an intended level. This intended level may be determined by the minimum daily dosage of the kimchi powder required to gain the beneficial effects of the kimchi powder. By fortifying the kimchi powder with the additional lactic acid bacteria, the minimum dosage may be lowered, which translates to the reduced production cost as well as consumer expense.

Mix bean sprout powder with kimchi powder: Bean sprouts may be freeze-dried and ground into a powder, then added to the kimchi powder prepared in the previous step. One of the benefits of the bean sprout powder may be that it can prevent expulsion of gas through the mouth, which can be very unpleasant after consuming the kimchi powder. Another benefit may be that, as well known to oriental medical society, the bean sprout helps digestion through its high dietary fiber content, as well as soothing the stomach.

In addition to these beneficial effects, the bean sprout powder can be used to control the salt concentration of the mixed powder. As bean sprout powder has no salt content, adjusting the amount of the bean sprout powder in the powder mixture can easily vary the salt concentration of the mixed powder. For example, if the weight ratio of kimchi powder to bean sprout powder is 1:1 or 1:2, the salt concentration of the mixed powder may be lowered to one half or one third of that of the original kimchi powder.

Contain the mixed powder in a form of tablet or capsule: By containing the mixed powder prepared in the previous step into a tablet or encapsulating its contents in a capsule, the product can be consumed without having to taste the kimchi itself. This way, kimchi powder can be commercialized and consumed by a wide variety of people, particularly those individuals who are not used to the taste and scent of traditional kimchi. As mentioned previously, the salt concentration in the initial preparation of the salted cabbage may be approximately 1-1.2%. During the freeze-drying process, because of the water loss associated with this type of procedure, the salt content may rise to approximately 9% by weight. However, by mixing the sprout powder into the kimchi powder, the salt concentration can be lowered to its intended level.

Mix fermented soybean powder with kimchi powder: In an alternative embodiment, prior to the step of containing the mixed powder in a form of tablet or encapsulating in a capsule, fermented soybean powder (called “chungkugjang”) may be added to the mixed powder. Mi-Yae Shon et al., Jour. Korean Soc. Food Sci. Nutr. 30 (4), 662-667 (2001), disclosed that fermented soybean powder can help to boost the stamina, prevent constipation, cleanse carcinogenic chemicals, lower cholesterol level, decompose alcohol and lactic acid, strengthen blood veins, promote blood circulation, prevent Alzheimer disease, lower blood pressure and prevent arteriosclerosis. Typically, fermented soybean may be made of black soybean using Bacillus subtilis as a fermenting agent, and does not contain salt. Fermented soybean is known to dissolve thrombus and help prevent diabetes and arteriosclerosis.

In addition to these beneficial effects, fermented soybean powder can also be used to control the salt concentration of the kimchi powder. By mixing the sprout powder, and/or fermented bean powder into the kimchi powder, the salt concentration can be lowered to its intended level.

Fermented bean powder may be prepared in two different methods. In a first embodiment, as in the traditional method, black soybeans may be washed, soaked into water, steamed and dewatered. Then, Bacillus subtilis may be added to the dewatered black soybeans. Subsequently, the soybeans may be fermented at predetermined conditions. In a second embodiment, to reduce the production cost and preserve beneficial nutrition, such as Vitamin C, black soy beans may be ground and Bacillus subtilis may be added to the ground black soybeans for fermentation without the process of steaming and dewatering.

As mentioned in previous steps, to fortify the kimchi powder with lactic acid bacteria, lactic acid bacteria may be added to the mixture of vegetable and condiments. Also, in order for the lactic acid bacteria to reach the intestine, a microcapsule may be applied on the surface of the lactic acid bacteria. To further fortify the kimchi powder with lactic acid bacteria, lactic acid bacteria may be incubated separately, turned into powder and added to the kimchi powder. In one embodiment, a water solution containing sugar, bean amino acid, citric acid and yeast extract may be used to incubate the lactic acid bacteria. The lactic acid bacteria may be harvested by centrifugation, coated with chitosan, and freeze-dried to make lactic acid bacteria powder. Then, the powder of lactic acid bacteria may be added to the kimchi powder prior to containing the mixed powder in a form of tablet or capsule.

Other types of powder may be added to the kimchi powder to provide consumers with various beneficial effects. In one embodiment, a green tea powder may be mixed with the kimchi powder as well. The green tea is known to have beneficial effects in preventing cancer and promoting weight loss by reducing body fat accretion, as disclosed by J. J. Choo in Journal of Nutritional Biochemistry, Vol. 11, 671-676 (2003). Thus, the green tea powder may have strong effect on weight loss when combined with other ingredients that may also contribute to weight loss. In another embodiment, a ginseng powder may be mixed with the kimchi powder, wherein the ginseng powder is prepared by the steps of steaming raw ginseng, drying the steamed ginseng and grinding the dried ginseng. As disclosed by Shin-II Kim et al. in Korean Journal of Ginseng Sci., Vol. 10, No. 2 (1986), the ginseng is known to have beneficial effects in weight loss by inhibiting lipogenesis in the liver and fat accumulation in the adipose tissues. In yet another embodiment, a ginseng fiber powder may be mixed with kimchi powder. The ginseng fiber powder may be made by the steps of extracting functional materials from raw ginseng, drying the remaining fiber of ginseng and grinding the dried fiber. Ginseng fiber powder is known to have similar beneficial effects as the ginseng powder; it may boost immune system and promote weight loss. In still another embodiment, both ginseng powder and ginseng fiber powder may be mixed with kimchi powder. In further another embodiment, a grape seed powder may be mixed with kimchi powder, where the grape seed powder is known to promote weight loss by reducing tissue fat levels, as disclosed by Anshu Mittal et al. in Carcinogenesis, Vol. 24, No. 8, pp. 1379-1388, 2003.

A better understanding of the present invention may be obtained in light of the following example, which is set forth to illustrate, but is not to be considered to limit the present invention.

Cabbage was cut in pieces, washed, rinsed, and dewatered thoroughly. Next, salt at an amount of 1-1.2% by weight of the cabbage was sprinkled on the cabbage to draw water therefrom and left for 5 hours. Then, the salted cabbage was mixed with condiments containing radish at amount of 15% by weight of the cabbage, onion at amount of 3% by weight of the cabbage, green onion at amount of 1.5% by weight of the cabbage, garlic at amount of 1.5% by weight of the cabbage, red pepper at amount of 1.5% by weight of the cabbage and ginger at amount of 1% by weight of the cabbage. Next, 10⁶-10⁷ cfu/g of Leuconostoc citreum were added to the mixture. Leuconostoc citreum were incubated in a solution that contains a liter of water, 10 grams of bean amino acid, 5 grams of yeast extract, 5 grams of citric acid, and 20 grams of sugar. Subsequently, kimchi was fermented for three days at 16° C. and aged for three days at 4° C. The aged kimchi was then freeze-dried and ground into powder at the size of mesh #80.

To prepare bean sprouts, soybeans were washed three times, drained for an hour and soak into water for two hours. Next, the soy bean sprouts were cultivated in a jar for seven days at 18° C. by watering the soaked soybeans for 15 minutes every hour. Then, cultivated soybean sprouts were dried and grounded into powder at the size of mesh #200 (or, equivalently, 75 microns).

To prepare fermented bean powder, black soybeans were washed three times, soaked into water for three hours, steamed for two hours and dewatered. Then, Bacillus subtilis were added to the dewatered black soybeans. Subsequently, the soybeans were fermented at 38-42° C. for two days, and 60° C. for another day. The fermented soybean powder was dried at 45-50° C. and grounded into powder at the size of mesh #80 or smaller.

The prepared kimchi powder, bean sprout powder and fermented bean powder were mixed at the ratio of 1:1:1 by weight. Then, 0.5 gram of this mixed powder was encapsulated in a capsule. Analysis showed that the contents in each capsule comprised 10⁹ cfu/g or more of Leuconostoc citreum, 10⁹ cfu/g or more of Bacillus subtilis from fermented bean powder, 15% by weight of dietary fiber, 1.5% by weight of salt, and 1% by weight of dextran.

Tables 1-6 illustrate the beneficial effects of the kimchi powder produced in accordance with one embodiment of the present teachings, wherein the kimchi powder acts as an agent to kill or suppress the multiplication of six types of food poisoning bacteria; Listeria monocytogene, Salmonella typhimurium, Salmonella enteriditis, Escherichia coli, Aeromonas hydrophilla and Clostridium perfringens. Each table is a matrix of bacteria population (in cfu) with row and column representing the incubation condition and hours lapsed from the start of incubation, respectively. Three incubation conditions are: BHI broth, BHI broth mixed with kimchi powder and BHI broth mixed with kimchi powder liquid, where the kimchi powder liquid is prepared by mixing water with the kimchi powder.

TABLE 1
Function of kimchi powder to suppress the
multiplication of Listeria monocytogens

| | 0 hour | 6 hours | 24 hours |
|---|---|---|---|
| BHI broth | 1.0 × 10⁸ | 6.1 × 10¹⁰ | 2.1 × 10¹³ |
| BHI broth + kimchi powder | 2.4 × 10⁸ | 4.8 × 10⁸ | 1.3 × 10⁸ |
| BHI broth + kimchi powder | 4.5 × 10⁸ | 8.3 × 10⁸ | 2.0 × 10⁷ |
| liquid | | | |

TABLE 2
Function of kimchi powder to suppress the
multiplication of Salmonella typhimurium

| | 0 hour | 6 hours | 24 hours |
|---|---|---|---|
| BHI broth | 2.0 × 10⁸ | 2.2 × 10¹⁰ | 3.3 × 10¹⁰ |
| BHI broth + kimchi powder | 3.0 × 10⁸ | 4.2 × 10⁸ | 1.3 × 10⁸ |
| BHI broth + kimchi powder | 5.0 × 10⁷ | 2.0 × 10⁸ | 1.8 × 10⁸ |
| liquid | | | |

TABLE 3
Function of kimchi powder to suppress the
multiplication of Salmonella enteriditis

| | 0 hour | 6 hours | 24 hours |
|---|---|---|---|
| BHI broth | 2.0 × 10⁸ | 3.7 × 10¹⁰ | 2.6 × 10¹¹ |
| BHI broth + kimchi powder | 2.0 × 10⁸ | 2.4 × 10⁸ | 4.0 × 10⁷ |
| BHI broth + kimchi powder | 2.0 × 10⁸ | 2.8 × 10⁸ | 1.6 × 10⁸ |
| liquid | | | |

TABLE 4
Function of kimchi powder to suppress the
multiplication of Escherichia coli
(O157:H7)

| | 0 hour | 6 hours | 24 hours |
|---|---|---|---|
| BHI broth | 1.9 × 10⁸ | 2.3 × 10¹⁰ | 2.6 × 10¹⁰ |
| BHI broth + kimchi powder | 1.6 × 10⁸ | 1.7 × 10⁸ | 1.4 × 10⁷ |
| BHI broth + kimchi powder | 1.9 × 10⁸ | 2.1 × 10⁸ | 5.3 × 10⁷ |
| liquid | | | |

TABLE 5
Function of kimchi powder to suppress the
multiplication of Aeromonas hydrophilla

| | 0 hour | 6 hours | 24 hours |
|---|---|---|---|
| BHI broth | 5.3 × 10⁷ | 2.3 × 10¹⁰ | 8.3 × 10⁸ |
| BHI broth + kimchi powder | 5.2 × 10⁷ | 0 | 0 |
| BHI broth + kimchi powder | 5.2 × 10⁷ | 0 | 0 |
| liquid | | | |

TABLE 5
Function of kimchi powder to suppress the
multiplication of Clostridium perfringens

| | 0 hour | 24 hours |
|---|---|---|
| BHI broth | 4.0 × 10⁶ | 2.8 × 10⁸ |
| BHI broth + kimchi powder | 1.3 × 10⁷ | 2.9 × 10⁵ |
| BHI broth + kimchi powder | 2.5 × 10⁶ | 1.4 × 10⁵ |
| liquid | | |

As can be noticed, the kimchi powder can suppress the growth of Listeria monocytogene, Salmonella typhimurium, Salmonella enteriditis, Escherichia coli (O157:H7), Clostridium perfringens and kill Aeromonas hydrophilla, which is another beneficial effect of the kimchi powder.

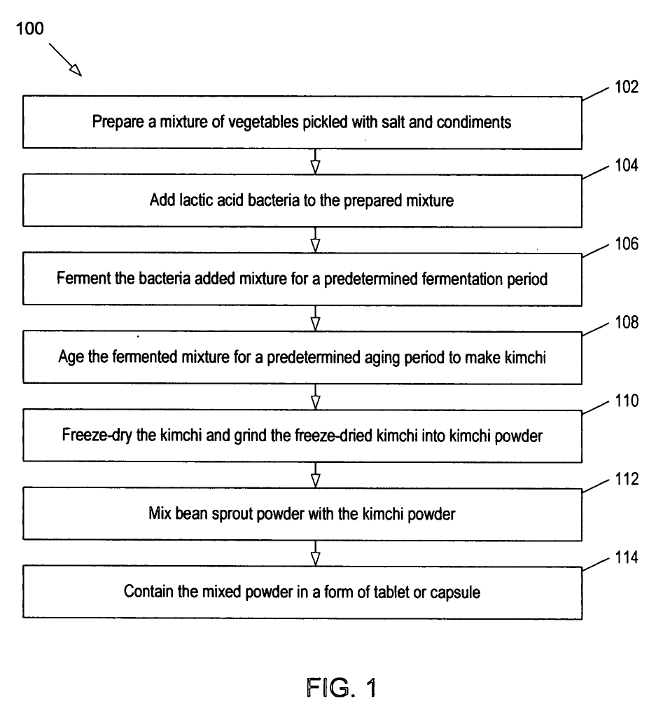

FIG. 1 a flow chart 100 illustrating exemplary steps of preparing powder that comprises kimchi in a form for easy consumption in accordance with one embodiment of the present teachings. In step 102, a mixture of vegetables pickled with salt and condiments may be prepared. To pickle the vegetables, salt at an amount of, but not limited to, 1-1.2% by weight of the vegetables may be sprinkled on the vegetables. Then, the water may be drawn out from the vegetables until a concentration of salt in the vegetables stops increasing. Next, in step 104, lactic acid bacteria, such as Leuconostoc citreum Leuconostoc cremoris, Leuconostoc lactis or Leuconostoc mesenteroides, may be added to the prepared mixture. The population of the added lactic acid bacteria may be preferably, but not limited to, about 10⁶-10⁷ cfu per gram of the prepared mixture. Subsequently, the bacteria added mixture may be fermented in step 106. The fermentation period may be less than three days at a temperature of 16-18° C. or longer than seven days at a temperature of 4-5° C. Then, in step 108, the fermented mixture may be aged about 3 days at a temperature of 0-4° C. to make kimchi.

The kimchi may be freeze-dried and ground into kimchi powder in step 110, where the kimchi powder may have a size of, but not limited to, about 180 microns. Then, in step 112, the kimchi powder may be mixed with bean sprout powder. The ratio of the kimchi powder to the sprout bean powder contained in the mixed powder may be preferably 1:1-1:2 by weight. Next, the mixed powder may be contained in a form of tablet or capsule for easy consumption in step 114.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, process, process step or steps, to the objective, spirit and scope of the present invention. All such modifications are intended to be within the scope of the claims appended hereto.

What is claimed is:

1. A method for preparing powder that comprises kimchi in a form for easy consumption, said method comprising the steps of:
preparing a mixture of vegetables pickled with salt and condiments;
adding lactic acid bacteria to the prepared mixture;
fermenting the bacteria added mixture for a predetermined fermentation period;
aging the fermented mixture for a predetermined aging period to make kimchi;
freeze-drying the kimchi and grinding the freeze-dried kimchi into kimchi powder;
mixing bean sprout powder with the kimchi powder; and
containing the mixed powder in a form of tablet or capsule.

2. The method of claim 1, further comprising, prior to the step of containing the mixed powder, adding fermented bean powder to the kimchi powder.

3. The method of claim 2, wherein a ratio of the kimchi powder to the sprout bean powder and fermented bean powder contained in the mixed powder is about 1:1:1 by weight.

4. The method of claim 1, wherein the step of preparing a mixture of vegetables pickled with salt and condiments comprises:
cutting the vegetables into pieces having processable sizes;
mixing the vegetables with salt at 1-1.2% by weight thereof; and
discarding water drawn out from the vegetables mixed with salt until a concentration of salt in the vegetables stops increasing.

5. The method of claim 1, wherein the condiments comprises radish at amount of 10-20% by weight of the vegetables, onion at amount of 2-5% by weight of the vegetables, green onion at amount of 1-2% by weight of the vegetables, garlic at amount of 1-2% by weight of the vegetables, red pepper at amount of 1-2% by weight of the vegetables, ginger at amount of 0.5-2.0% by weight of the vegetables and bean amino acid at amount of 5% by weight of the vegetables.

6. The method of claim 1, wherein the condiments comprises cystein, tryptophan or both.

7. The method of claim 1, wherein a population of the added lactic acid bacteria is about 10⁶-10⁷ cfu per gram of the prepared mixture.

8. The method of claim 1, wherein the predetermined fermentation period is shorter than three days at a temperature of 16-18° C.

9. The method of claim 1, wherein the predetermined fermentation period is at least seven days at a temperature of 4-5° C.

10. The method of claim 1, wherein the predetermined aging period is 3 days at a temperature of 0-4° C.

11. The method of claim 1, wherein the kimchi powder has a size of about 180 microns.

12. The method of claim 1, wherein a ratio of the kimchi powder to the sprout bean powder contained in the mixed powder is 1:1-1:2 by weight.

13. The method of claim 1, further comprising the step of, prior to the step of freeze-drying the kimchi, adding chitosan to the aged kimchi.

14. The method of claim 1, wherein the lactic acid bacteria is Leuconostoc citreum Leuconostoc cremoris, Leuconostoc lactis or Leuconostoc mesenteroides.

15. The method of claim 1, further comprising the step of, prior to the step of containing the mixed powder, adding powder of lactic acid bacteria to the mixed powder.

16. The method of claim 15, wherein each lactic acid bacterium of the lactic acid bacteria powder is coated with chitosan.

17. The method of claim 1, further comprising the step of, prior to the step of containing the mixed powder, adding green tea powder to the mixed powder.

18. The method of claim 1, further comprising the step of, prior to the step of containing the mixed powder, adding ginseng powder, ginseng fiber powder or both to the mixed powder.

19. The method of claim 1, further comprising the step of, prior to the step of containing the mixed powder, adding grape seed powder to the mixed powder.

20. The method of claim 1, wherein the vegetables comprise one or more elements selected from the group consisting of Chinese cabbage, Western cabbage, Napa cabbage, radishes, cucumbers, mustard greens, dandelions, chicory, endives, perilla leaves, bell flower plan roots, leeks, chives, garland chrysanthemum, kales, burdocks, ginseng root, collard greens, lettuce, squash and broccoli.
